(19) United States
(12) Patent Application Publication
(10) Pub. No.: US 2016/0283137 A1
(43) Pub. Date: Sep. 29, 2016

(54) STORAGE CONTROL SYSTEM, STORAGE CONTROL DEVICE AND PROGRAM

(71) Applicants: BIOS CORPORATION, Shibuya-ku (JP); MELCO HOLDINGS INC., Nagoya-shi (JP)

(72) Inventor: Seimei MATSUMURA, Shibuya-ku (JP)

(73) Assignees: BIOS CORPORATION, Shibuya-ku (JP); MELCO HOLDINGS INC., Nagoya-shi (JP)

(21) Appl. No.: 15/081,519

(22) Filed: Mar. 25, 2016

(30) Foreign Application Priority Data
Mar. 27, 2015 (JP) 2015-066962

(51) Int. Cl. G06F 3/06; G06F 12/08

(52) U.S. Cl. CPC G06F 3/0611; G06F 12/0866; G06F 3/0659; G06F 3/0689; G06F 2212/1024; G06F 2212/224; G06F 2212/60

(57) ABSTRACT

A storage control device is connected to a disk device that retains write commands including area specifying information specifying areas as write targets and including write object data as write objects and performs writing onto a disk based on the retained write commands. The storage control device includes a controller cache memory in which data read from the disk device is cached, and controller circuitry that generates a write command for writing write object data of a write command received at a second point of time later than a first point of time and gap data between an area specified by area specifying information included in the write command received at the second point of time and an area specified by area specifying information included in the write command received at the first point of time, and outputs the generated write command to the disk device.

### CROSS-REFERENCE TO RELATED APPLICATION

This application claims priority from Japanese Patent Application No. 2015-066962, filed on Mar. 27, 2015, the entire subject matter of which is incorporated herein by reference.

### TECHNICAL FIELD

Aspects of the present disclosure relate to a storage control system and a storage control device which can be connected to a disk device such as a Redundant Arrays of Independent Disks (RAID) device.

### BACKGROUND

JP-A-2006-163474 discloses a RAID device. In a case where it is required to issue a write command at least three times, the RAID device reads discontinuous areas of dirty data included in cache data which is managed in the unit of a page, from a storage device, and merges the read data into one continuous dirty data area in the page, thereby performing a write back process by the total two times of command issuance, that is, one time of issuance of a read command for reading data of discontinuous areas from the storage device and one time of issuance of a write command for merging data, read from discontinuous sections in response to the read command, into a continuous dirty data section.

However, in the RAID device described above, the reading operation based on a read command is required. In a case of continuously writing data on a disk device having a rotating medium, since read commands and write commands are frequently issued, the RAID device waits for an area designated as a read target by a read command to reach the position of a head of the disk device, and waits for an area designated as a write target by a write command to reach the position of the head of the disk device. Consequently, the RAID device should stand by for a period when the rotating medium rotates by 360 degrees or more. For this reason, for example, in a case of repeatedly writing discontinuous data having relatively small sizes (such as a plurality of files having relatively small sizes), overhead increases.

### SUMMARY

According to an embodiment of the present disclosure, there is provided a storage control device connected to a disk device which is configured to retain write commands including area specifying information specifying areas as write targets and including write object data as write objects and perform writing onto a disk based on the retained write commands. The storage control device comprises: a controller cache memory, data read from the disk device being cached in the controller cache memory; an interface configured to receive write commands; a controller memory configured to retain area specifying information included in write commands received at a first point of time; and controller circuitry configured to perform a write command generating process of generating a write command for writing write object data of a write command received at a second point of time later than the first point of time and gap data between an area specified by area specifying information included in the write command received at the second point of time and an area specified by area specifying information included in the write command received at the first point of time, in case it is determined that the gap data has been cached in the controller cache memory, with reference to the area specifying information included in the write commands received at the first point of time and retained in the controller memory; and output the generated write command to the disk device.

Other embodiments of the present disclosure provide a storage control system including the disk device and the storage control device, a method of performing operation of the storage control device, and a computer-readable non-transitory storage medium having a program stored therein which causes the storage control device to operate.

### BRIEF DESCRIPTION OF THE DRAWINGS

The above and other aspects of the present disclosure will become more apparent and more readily appreciated from the following description of embodiments of the present disclosure taken in conjunction with the attached drawings, in which:

FIG. 1 is a block diagram illustrating an example of the configuration of a storage control system according to an embodiment of the present disclosure;

FIG. 2 is an explanatory view illustrating an example of the data storage state of a disk device of the storage control system according to the embodiment of the present disclosure;

FIG. 3 is an explanatory view illustrating an example of logical sectors and a segment in the storage control system according to the embodiment of the present disclosure;

FIG. 4 is an explanatory view related to the operation of a storage control device of the storage control system according to the embodiment of the present disclosure;

FIG. 5 is an explanatory view illustrating an example of the content of a target area history list which is retained by the storage control device of the storage control system according to the embodiment of the present disclosure;

FIG. 6 is an explanatory view illustrating an example of data which is handled in the storage control system according to the embodiment of the present disclosure;

FIGS. 7A to 7D are explanatory views illustrating the relation between target sectors and fractions which are included in data which is handled in the storage control system according to the embodiment of the present disclosure;

FIG. 8 is a flow chart illustrating operation examples during data writing of the storage control system according to the embodiment of the present disclosure; and

FIG. 9 is an explanatory view illustrating operation examples of the storage control system according to the embodiment of the present disclosure.

### DETAILED DESCRIPTION

An aspect of the present disclosure has been made in view of the above-described circumstances, and an embodiment of the present disclosure provides a storage control system and a storage control device capable of improving the speed of a writing operation even in a case of repeatedly writing discontinuous data having relatively small sizes onto a disk device having a rotating medium.

According to the above described configuration, even in a case of repeatedly writing discontinuous data having relatively small sizes onto a disk device having a rotating medium, it is possible to improve the speed of a writing operation.

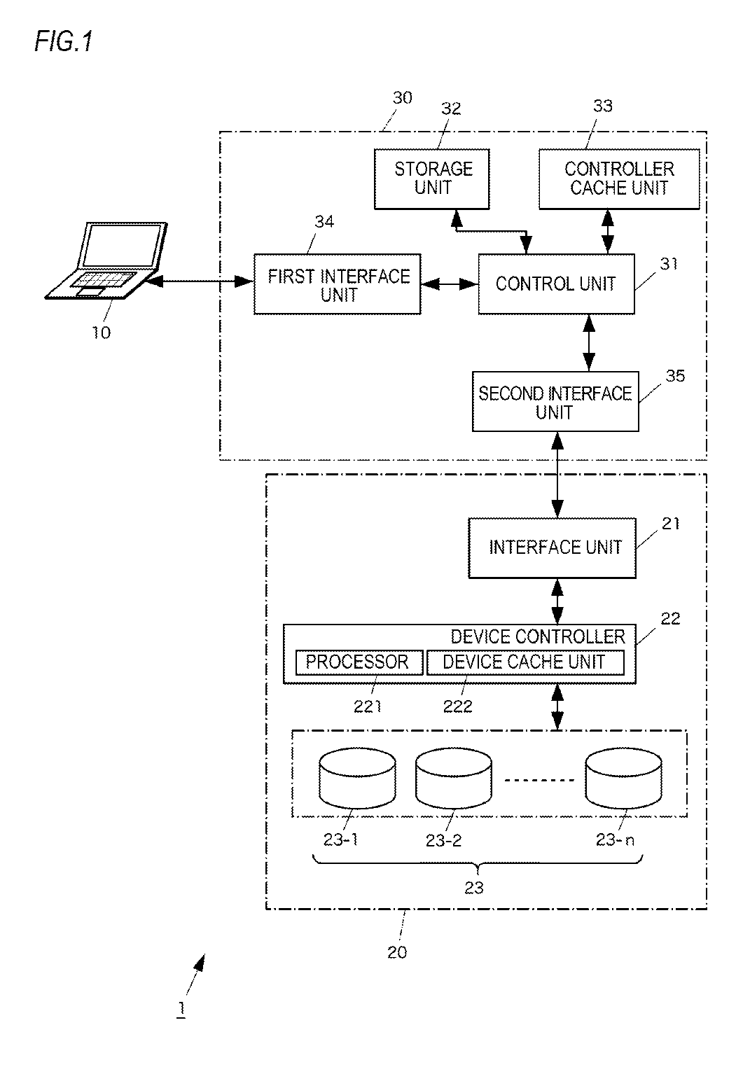

An embodiment of the present disclosure will be described with reference to the accompanying drawings. As shown in FIG. 1, a storage control system 1 according to an embodiment of the present disclosure is connected to a host side device 10 such as a personal computer (PC), and includes a disk device 20 and a storage control device 30.

Here, the disk device 20 is configured so as to include an interface unit 21, a device controller 22, and disk drives 23. Here, the disk drives 23 are rotating media (recording media) having speed differences between random access and sequential access, such as hard disk drives (HDD) and optical disk drives like Blu-ray (trademark) disk drives. Also, the storage control device 30 is configured so as to include a control unit 31, a storage unit 32, a controller cache unit 33, a first interface unit 34, and a second interface unit 35.

The interface unit 21 of the disk device 20 is connected to the storage control device 30. The interface unit 21 receives various commands such as a write command which includes information specifying an area (a target area) as a write target and includes write object data as a write object and a read command, from the storage control device 30, and outputs the received commands to the device controller 22. Also, the interface unit 21 receives data as an output object from the device controller 22, and outputs the corresponding data to the storage control device 30. Here, information specifying a target area includes the logical block address (LBA) of the head of the target area and a write object data length (logical block number (LBN)). Therefore, the LBA of the last of the target area is obtained by adding the LBA of the head of the target area and the length LBN.

As shown in FIG. 1, the device controller 22 includes a processor 221 and a device cache unit 222. The processor 221 is, for example, a micro computer, and operates, for example, according to a program stored in the processor 221 (or an external memory). If the processor 221 receives write commands through the interface unit 21, the processor 221 saves the corresponding write commands in the device cache unit 222, in the order of reception. Then, if a predetermined timing comes, the processor 221 performs a writing process with respect to the write commands retained in the device cache unit 222.

Here, the predetermined timing may be a timing which is after a predetermined time from a previous writing process, or may be a timing when the amount of data of write commands retained in the device cache unit 222 exceeds a predetermined threshold value. Alternatively, the predetermined timing may include a timing when a instruction to flush (a forced write instruction) is received through the interface unit 21.

In this writing process, the processor 221 of the device controller 22 sequentially selects the write commands retained in the device cache unit 222, in the order of reception, as a selection write command, and performs the following process.

In other words, with reference to an area designated as a write target by a selection write command, the processor 221 of the device controller 22 examines whether any other write command for writing data in an area adjacent to the write target area is retained after the selection write command in the device cache unit 222. Specifically, with reference to the LBA (LBA1_head) of the head of the target area and the LBA (LBA1_last) of the last of the target area included in the selection write command, the processor 221 retrieves any other write command for performing writing into an area having the LBA (LBA_head) of the head of the target area equal to or smaller than (LBA1_last+1) or having the LBA (LBA_last) of the last of the target area equal to or larger than (LBA1_head−1), from the device cache unit 222.

If any other write command satisfying the above described condition is retrieved, the processor 221 synthesizes the selection write command and the retrieved write command, thereby generating one write command. Specifically, on the assumption that the LBA of the head of a target area designated by information included in the retrieved write command is LBA_head, and the LBA of the last of the corresponding target area is LBA_last, and write object data which should be written by the retrieved write command is D, the processor 221 performs the following process.

(1) In a case where a condition of [LBA1_last+1<(LBA_last)] is satisfied, the processor generates a write command which specifies a smaller one of LBA1_head and LBA_head, as the LBA of the head of a target area, and specifies LBA_last, as the LBA of the last of the target area. In this case, if LBA1_head is smaller than LBA_head, the write command is generated so as to include write object data such that a part of the write object data D1 of the selection write command is written from LBA1_head to (LBA_head−1) and the write object data D of the retrieved write command is written from LBA_head to LBA_last; whereas, if LBA1_head is not smaller than LBA_head, the write command is generated so as to include write object data such that the write object data D of the retrieved write command is written.

(2) If a condition of [LBA1_head≦LBA_head<LBA_last≦LBA1_last] is satisfied, the processor generates a write command which specifies LBA1_head as the LBA of the head of a target area and specifies LBA1_last as the LBA of the last of the target area. In this case, the write command is generated so as to include, as write object data, data obtained by overwriting a part of the write object data D1 of the selection write command corresponding to a portion from LBA_head to LBA_last with the write object data D of the retrieved write command.

(3) If a condition of [LBA_head≦(LBA1_head−1)] is satisfied, the processor generates a write command which specifies LBA_head as the LBA of the head of a target area and specifies a larger one of LBA1_last and LBA_last as the LBA of the last of the target area. In this case, if LBA_last is smaller than LBA1_last, the write command is generated so as to include write object data such that the write object data D of the retrieved write command is written from LBA_head to LBA_last and a part of the write object data D1 of the selection write command is written from (LBA_last+1) to LBA1_last; whereas if LBA_last is not smaller than LBA1_last, the write command is generated so as to include write object data such that the write object data D of the retrieved write command is written.

Subsequently, the processor 221 replaces the selection write command with the generated write command, and deletes the retrieved write command from the device cache unit 222, and selects the next write command as a selection write command, and repeats the above described process.

If any write command satisfying the above described condition is not retrieved with respect to the selection write command, the processor 221 selects the next write command as a selection write command, and repeats the above described process.

Also, if there is no next write command (the process is performed with respect to all of the write commands), the processor 221 performs a writing operation based on each write command recoded in the device cache unit 222.

Also, in a case where the device controller 22 receives a read command through the interface unit 21, it reads the read object data from the disk drives 23, and outputs the corresponding data to the interface unit 21.

In an example of the present embodiment, the device controller 22 functions a Redundant Arrays of Independent Disks (RAID) controller. In this example, a plurality of disk drives 23 is provided (it is assumed that the number of disc devices is “n”), and the plurality of disk drives 23 operate a RAID array. The following description of the present embodiment will be made on the assumption that the device controller 22 functions as a RAID controller. However, the present embodiment is not limited to a case where the disk drives 23 form a RAID array.

In an example of the present embodiment, at least three disk drives 23 are provided (n≧3), and the device controller 22 manages the disk drives 23-1, . . . , and 23-n, in units of storage areas (chunks) having a predetermined data length LC. Also, in this example, the device controller 22 divides write object data in units of a data length (a segment length) [(n−p)×LC] which is the product of the data length LC of a chunk and a value (n−p) obtained by subtracting the number “p” of parities from the number “n” of disk drives 23, thereby obtaining data segments A, B, . . . . In order to simplify the following description, it is assumed that “p” is 1. In this case, the device controller 22 divides write object data in units of a data length [(n−1)×LC], thereby obtaining data segments A. B, . . . .

In other words, in this example, the device controller 22 sets the individual data segments as parity generation units, respectively, and generates parity data A parity, B parity, . . . , in association with the data segments A, B, . . . having the data length [(n−1)×LC], respectively. Also, in association with the obtained data segments, the device controller 22 selects disk drives 23 for storing their parity data, respectively.

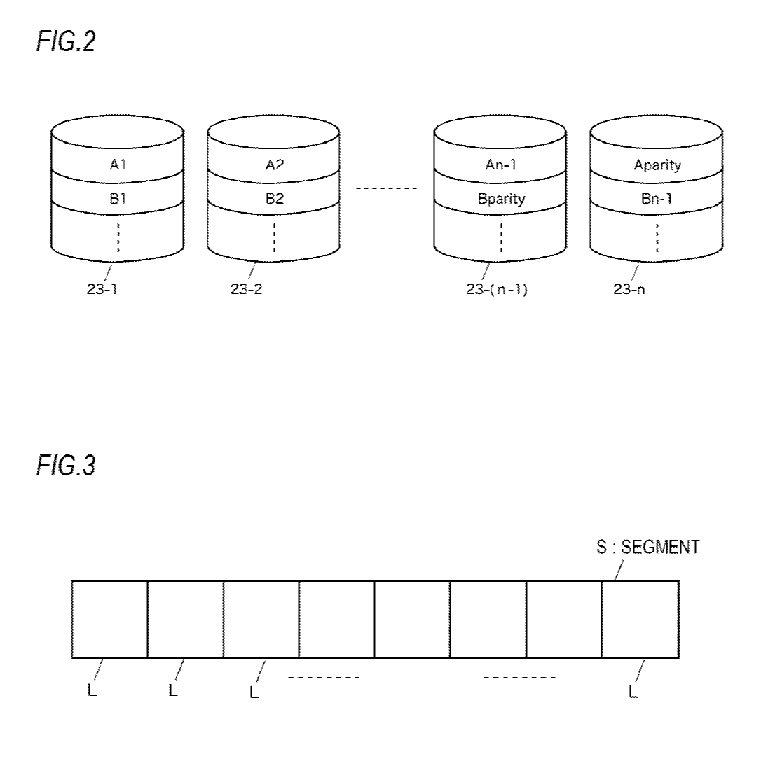

For example, the device controller 22 divides the individual data segments into the chunks A1, A2, . . . , An−1, B1, B2, . . . , Bn-1, . . . having the length LC, and stores the parity data A parity corresponding to the data segment A, in the disk drive 23-n, and stores the chunks A1, A2, . . . , and An−1 obtained by dividing the data segment A, in storage areas (the positions of which are specified by an LBA included in a write command) of the (n−1)-number of disk drives 23-1, . . . , and 23-(n−1), respectively, except for the disk drive 23-n selected as the parity data storage location (FIG. 2).

Also, the device controller 22 stores the parity data B parity corresponding to the data segment B in the disk drive 23-(n−1), and stores the data B1, B2, . . . , and Bn−1 obtained by dividing the data segment B, in the disk drives 23-1, . . . , 23-(n−2), and 23-n, respectively. This storing system is known as so-called RAID 5, and thus a detailed description thereof will not be made below.

In areas S where the data segments A, B, . . . are stored (these areas are distributed in the (n−1)-number of disk drives 23 and will be hereinafter referred to as segments), as shown in FIG. 3, the N-number of logical sectors L is included (wherein, “N” is an integer). In association with the segments, the device controller 22 retains information (LBA) specifying logical sectors included in the segments, as map information.

Also, in this example of the present embodiment, the device controller 22 receives, as a read command, information specifying an area retaining read object data (an LBA specifying a logical sector included in the corresponding area). Further, with reference to the map information, the device controller 22 specifies a segment including the logical sector specified by the received information.

The device controller 22 reads data included in the specified segment, and a corresponding parity data, from the disk drives 23-1, . . . , and 23-n. Here, the device controller 22 performs a process of performing error detection and correction on the data included in the segment, with the parity data. As this process, a process widely known as a RAID process can be used as it is, and thus a detailed description thereof will not be made.

Subsequently, the device controller 22 extracts a data part included in the logical sector specified by the information included in the read command (in a case where the information included in the read command corresponds to the whole of the segment, the data of the whole of the segment), from the data read from the disk drives 23, and outputs the data part to the storage control device 30 through the interface unit 21.

The control unit 31 of the storage control device 30 is a program control device such as a CPU, and operates according to a program stored in the storage unit 32.

Also, the control unit 31 may be configured by hardware. Specifically, the control unit 31 may be configured by a field programmable gate array (FPGA) and an application specific integrated circuit (ASIC).

Specifically, if the control unit 31 receives a write command from the host side device 10, it operates as follows. The write command includes write object data to be written, and information specifying a target area in which the write object data should be written (for example, a LBA specifying a logical sector as a storage location).

The control unit 31 saves the target-area specifying information of the write command in the storage unit 32. Also, with reference to information retained in the storage unit 32, the control unit 31 examines whether gap data between the target area of the write command received at the current time and a target area of any other write command received in the past has been cached in the controller cache unit 33.

If gap data has been cached in the controller cache unit 33, the control unit 31 performs a write command generating process of generating a write command representing that it is required to write the cached gap data and the write object data of the write command received at the current time, and outputs the generated write command to the disk device 20. The operations of the control unit 31 of the present embodiment will be described in detail below.

The storage unit 32 is, for example, a memory device retaining programs to be executable by the control unit 31. The programs which are retained in the storage unit 32 may be programs read from computer-readable non-transitory recording media retaining the corresponding programs and stored in the storage unit, and may be programs acquired through a communication means such as a network. In the present embodiment, the storage unit 32 operates as a work memory of the control unit 31.

The controller cache unit 33 is a memory device which functions as a cache in the storage control device 30. In an aspect of the present embodiment, the controller cache unit 33 may be implemented as a part of the storage unit 32. The first interface unit 34 is connected to the host side device 10, whereby the control unit 31 and the host side device 10 exchange data and commands. The second interface unit 35 is connected to the disk device 20, whereby the control unit 31 and the disk device 20 exchange data and commands.

[Operations of Control Unit]

Now, the operations of the control unit 31 will be described. In an example of the present embodiment, since gap data between the target area of the write command received at the current time and the target area of a write command received at the previous time has been cached in the controller cache unit 33, the control unit 31 improves the speed of a writing process. Therefore, in the present embodiment, in a writing process based on a write command, the control unit 31 reads data of an area larger than the target area where data will be actually written in response to the corresponding write command, from the disk device 20, and overwrites a part of data part with the write object data specified by the write command, and writes the corresponding data back in the disk device 20.

As a specific example, in the present embodiment, the control unit 31 may read data of an area larger than an area where data will be actually written in response to a write command, in a fraction process.

With respect to this example, in an embodiment, in association with the segments of the disk device 20, the storage control device 30 retains information specifying logical sectors included in the corresponding segments, as map information. This map information is the same as that retained in the device controller 22. Also, among the operations of the control unit 31, an operation when the control unit 31 performs if receiving a read command from the host side device 10 is the same as that in the example according to the related art, and thus a detailed description thereof will not be made here.

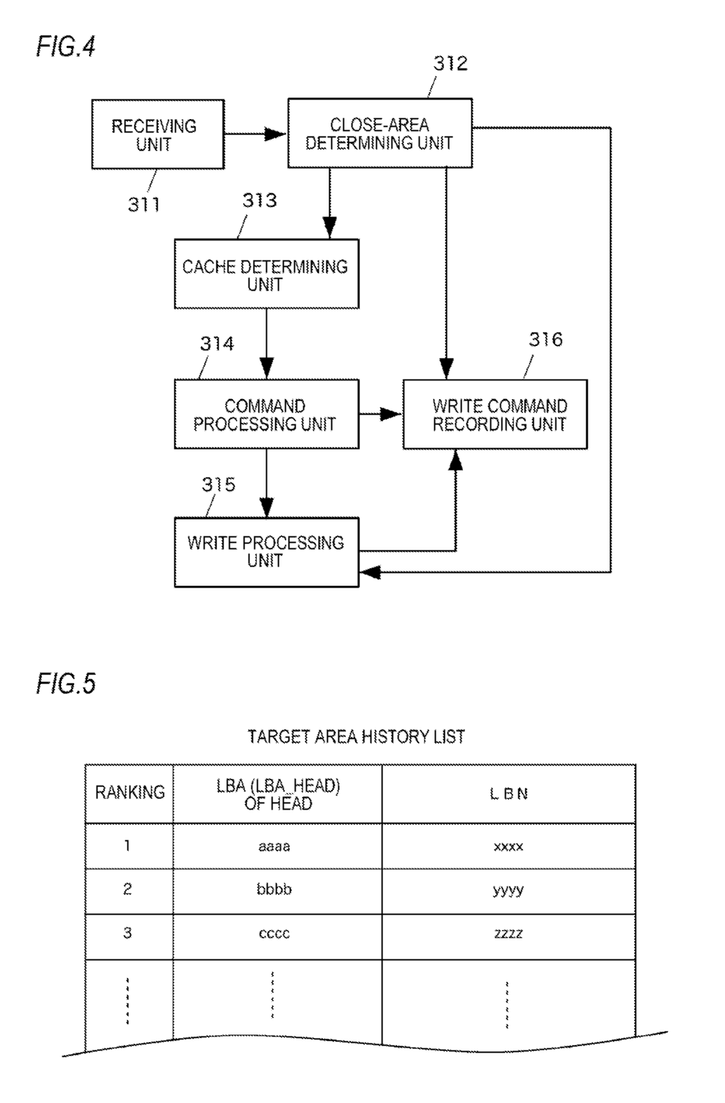

If the control unit 31 receives a write command from the host side device 10, it performs the following process. Specifically, the control unit 31 of the present embodiment executes a program stored in the storage unit 32, thereby implementing functional components shown in FIG. 4. In other words, the control unit 31 which executes the corresponding program functionally operates as a receiving unit 311, a close-area determining unit 312, a cache determining unit 313, a command processing unit 314, a write processing unit 315, and a write command recording unit 316.

Also, in the present embodiment, a list of information representing target areas where data has been written in the past as shown in FIG. 5 is recorded as a target area history list in the storage unit 32. This will be described below. The target area history list is recorded by the operation of the write command recording unit 316, and includes a N-number of information specifying a target area included in write commands output to the disk device 20 in the past (these information include the LBAs (LBA_head) of the heads of corresponding areas and write object data lengths LBN, or include the LBAs (LBA_head) of the heads of the corresponding areas and the LBAs (=LBA_head+LBN) of the corresponding areas.

The receiving unit 311 receives commands such as a write command from the host side device 10 through the first interface unit 34. A write command which the receiving unit 311 receives from the host side device 10 includes write object data to be written, and information representing a target area where the corresponding write object data will be written (information including the LBA (LBA_head) of the head of the corresponding area and a write object data length LBN, or including the LBA (LBA_head) of the head of the corresponding area and the LBA (=LBA_head+LBN) of the corresponding areas.

If the receiving unit 311 receives a write command including information specifying a target area, with reference to the target area history list recorded in the storage unit 32, the close-area determining unit 312 retrieves information specifying an area closet to the corresponding target area (the closest area), from the information included in the target area history list. If information specifying the closest area is found by the retrieval, the close-area determining unit 312 outputs the corresponding information to the cache determining unit 313. Also, the close-area determining unit 312 outputs information (index information) representing what number the closest-area specifying information found by the retrieval is in the target area history list, to the write command recording unit 316. Meanwhile, in a case where there is no information recorded in the target area history list, the close-area determining unit 312 outputs the write command received at the current time by the receiving unit 311, to the write processing unit 315.

Also, in an example of the present embodiment, if the receiving unit 311 receives a write command including information specifying a target area, with reference to the target area history list recorded in the storage unit 32, the close-area determining unit 312 may retrieve information specifying an area having a gap smaller than a predetermined gap from the target area, as information specifying an area closet to the target area, from the information included in the target area history list. Even in this case, the close-area determining unit 312 outputs the area specifying information found by the retrieval, to the cache determining unit 313, and outputs information (index information) representing what number the area specifying information found by the retrieval is in the target area history list, to the write command recording unit 316.

In this case, if any area specifying information is not found by the retrieval, where the receiving unit 311 receives a write command including information specifying a target area, such as a case where the target area history list includes only information having gaps larger than the predetermined gap from the target area specified by the information included in the write command received by the receiving unit 311 (or a case where the target area history list does not include any information), the close-area determining unit 312 outputs the write command received by the receiving unit 311, to the write processing unit 315.

The cache determining unit 313 determines whether gap data between the area represented by the information output from the close-area determining unit 312 and the target area of the write command received at the current time has been cached in the controller cache unit 33. For example, in a case where the head LBA and last LBA (LBA1_head+LBN) of the area represented by the information output from the close-area determining unit 312 is equal to LBA1_head and LBA_last, respectively, and the LBA of the head of the target area of the write command received at the current time is equal to LBA_head (wherein, LBA1_last<LBA_head), if the whole of data stored in an area from LBA1_last+1 to LBA_head−1 has been cached in the controller cache unit 33, the cache determining unit 313 determines that gap data has been cached in the controller cache unit 33. Meanwhile, if the whole of data stored in the area from LBA1_last+1 to LBA_head−1 has not been cached in the controller cache unit 33, the cache determining unit 313 determines that gap data has not been cached in the controller cache unit 33.

In the case where the cache determining unit 313 determines that gap data has been cached in the controller cache unit 33, the command processing unit 314 generates a write command, using the gap data and the write command received at the current time (hereinafter, this process will be referred to as a merging process). Specifically, when it is assumed that the head LBA and last LBA of an area corresponding to gap data Dm are equal to LBAm_head and LBAm_last, respectively, the command processing unit 314 performs a merging process as follows.

(1) In a case where a condition [LBAm_last=(LBA_head−1)] is satisfied, the command processing unit 314 performs a merging process, thereby generating a write command for continuously writing the gap data Dm and the write object data D of the write command received at the current time in an area from LBAm_head to LBA_last.

(2) In a case where a condition of [(LBA_last+1)=LBAm_head] is satisfied, the command processing unit 314 performs a merging process, thereby generating a write command for continuously writing the gap data Dm and the write object data D of the write command received at the current time in an area from LBA_head to LBAm_last.

The command processing unit 314 outputs the generated write command to the write processing unit 315. Meanwhile, in a case where the cache determining unit 313 determines that gap data has not been cached in the controller cache unit 33, the command processing unit 314 outputs the write command received at the current time, to the write processing unit 315, without performing a merging process. Also, in a case where the command processing unit 314 has performed a merging process, it outputs information representing that the merging process has been performed, to the write command recording unit 316.

As described above, in the present embodiment, a write command generating process is performed by the cache determining unit 313 and the command processing unit 314.

If the write processing unit 315 receives a write command input from the close-area determining unit 312 or the command processing unit 314, it outputs the received write command to the disk device 20. Also, the write command recording unit 316 receives target-areas specifying information included in the write command output from the write processing unit 315 to the disk device 20, and records the received information in the storage unit 32.

In an example of the present embodiment, the write command recording unit 316 may record target-areas specifying information included in write commands output at the N-number of latest times, as the target area history list, or may record the target area history list as a least recent used (LRU) list as will be described below.

### [Process of Reading Expanded Area]

Also, in the present embodiment, at least in a case where the input write command is the write command received at the current time by the receiving unit 311, not a command generated by the command processing unit 314, in the subsequent process of generating a write command, in order to improve the hit rate of gap data, the write processing unit 315 caches the data of an expanded area including not only the target area of the corresponding write command but also an area continuous to the corresponding target area, in the controller cache unit 33.

Here, if the data of the expanded area is retained in the controller cache unit 33, the write processing unit 315 may acquire the corresponding data from the controller cache unit 33. Meanwhile, if the whole or a part of the corresponding data is not retained in the controller cache unit 33, the write processing unit 315 may output a read command for reading the whole or a part of the corresponding data, to the disk device 20, and receive data read in response to the read command, from the disk device 20. Like in the later case, in a case of receiving the corresponding data from the disk device 20, the write processing unit 315 caches the received data in the controller cache unit 33. In this case, in association with the data which is cached, the first LBA of LBAs (request LBAs) included in the output read command may be recoded.

If the data cached in the controller cache unit 33 includes a data part corresponding to the write target area, the write processing unit 315 rewrites the corresponding data part with the write object data included in the write command, thereby updating the data cached in the controller cache unit 33. Meanwhile, if the data cached in the controller cache unit 33 does not include a data part corresponding to the write target area, the write processing unit 315 adds a data part corresponding to the target area, to the data cached in the controller cache unit 33, thereby updating the data cached in the controller cache unit 33.

Thereafter, the write processing unit 315 sets the updated data cached in the controller cache unit 33, as new write object data, and generates a new write command including information specifying a target area corresponding to the new write object data, and outputs the new write command to the disk device 20.

However, in this case, the write processing unit 315 does not necessarily need to set the whole of the updated data as new write object data, and may extract a part including data of a parity generation unit, which includes the part rewritten with the write object data included in the write command received from the host side device 10, or the part obtained by adding the write object data included in the write command, from the updated data, and set the extracted part as new write object data.

[Example of Fraction Process]

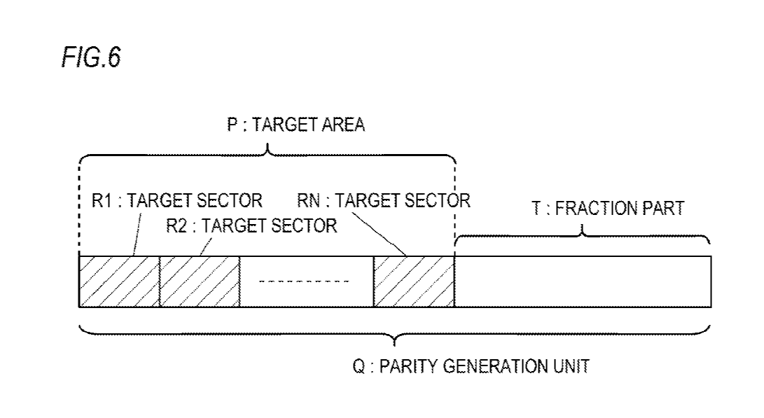

Specifically, the write processing unit 315 according to an example of the present embodiment performs the process of reading an expanded area, as a part of a fraction process. In this example, the write processing unit 315 receives an input of a write command including information specifying a target area. In this case, as shown in FIG. 6, the target area (P) specified by the input information includes a plurality of logical sectors R1, R2, . . . (hereinafter, referred to as target sectors), but this target area does not necessarily match a parity generation unit (Q). In other words, a parity generation unit includes target sectors and a part (a fraction part T) which is not a target sector.

Hereinafter, data recorded in the target sectors will be referred to as sector data, and data recorded in the fraction part will be referred to as fraction data. In a parity generation unit, sector data and fraction data are included.

The write processing unit 315 determines whether the controller cache unit 33 retains data (hereinafter, referred to as processing target data) including at least a part which is included in data including at least one parity generation unit including fraction data and the sector data recorded in logical sectors (target sectors) included in the target area specified by the information included in the input write command but does not include the sector data.

In this example of the present embodiment, since a parity generation unit is generated in units of a segment, the write processing unit 315 determines whether the controller cache unit 33 retains data which is included in data including a segment including a target sector (in a case where the target sector extends over a plurality of segments, the whole of the plurality of segments) but does not include the target sector. If the controller cache unit 33 retains data which is included in data including the segment including the target sector (in a case where the target sector extends over a plurality of segments, the whole of the plurality of segments) but does not include the target sector, the write processing unit 315 sets the data including the segment including the target sector, as processing target data, and reads the corresponding data from the controller cache unit 33.

In other words, based on the input write command, the write processing unit 315 reads the processing target data cached in the controller cache unit 33. In this case, if the read processing target data includes a data part corresponding to the sector data recorded in the target sector, the write processing unit 315 rewrites the corresponding data part with the write object data included in the write command, thereby updating the processing target data. Meanwhile, in a case where the read processing target data does not include a data part corresponding to the sector data, the write processing unit 315 adds the write object data included in the write command, to the read processing target data (a part thereof corresponding to the sector data), thereby updating the processing target data. Also, the part corresponding to the sector data is determined based on information designating the location of the read source of the processing target data cached in the controller cache unit 33 (information specifying the location of a sector).

The write processing unit 315 outputs the updated processing target data, as write object data, to the disk device 20. Also, in this case, the write processing unit 315 outputs the head LBA and last LBA of logical sectors which are the storage location of the updated processing target data, as information specifying a target area. Further, in this case, the write processing unit 315 replaces the processing target data cached in the controller cache unit 33, with the updated processing target data (caching using a write-through system). In this time, if a fraction has occurred, the updated processing target data which is output as write object data is data including not only the data included in the write command but also the corresponding fraction; whereas if any fraction has not occurred, the updated processing target data is the data included in the write command.

Meanwhile, in a case where it is determined that the controller cache unit 33 does not retain data corresponding to the processing target data (such as a case where it is determined that the controller cache unit 33 retains a part of data corresponding to the processing target data but does not retain the whole of the data corresponding to the processing target data), the write processing unit 315 acquires at least a partial data of the processing target data from the disk device 20 such that the processing target data can be retained in the controller cache unit 33.

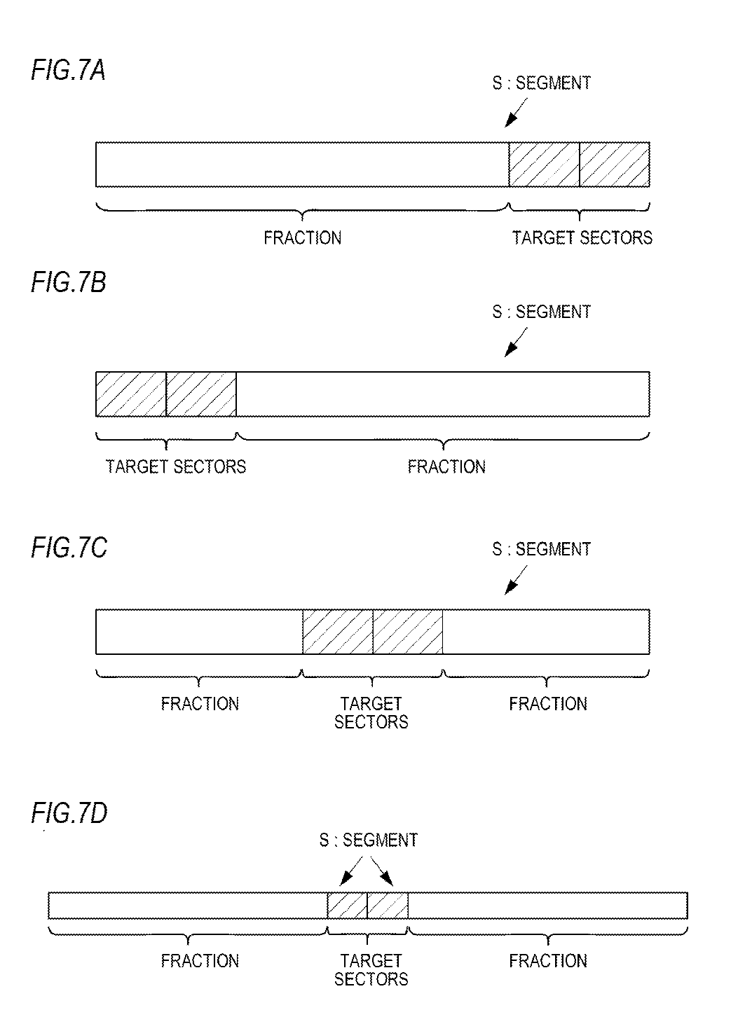

Specifically, in a case where it is determined that the controller cache unit 33 does not retain data corresponding to the processing target data, the write processing unit 315 performs an data reading operation by any one of the following methods. In other words, in an example of the present embodiment, as shown in FIGS. 7A to 7D, a segment of the disk device 20 includes a plurality of logical sectors (L). Therefore, in general, in a segment (S) which is a data read/write unit of the disk device 20, before and after logical sectors (L) corresponding to a target area of a write command, data (that is, fraction data) which cannot be rewritten by the corresponding write command is also included. For this reason, the write processing unit 315 performs a process of reading processing target data (at least a missing part of processing target data) by (1) a method of reading necessary minimum data or (2) a method of reading data more than necessary minimum data. Hereinafter, these methods will be described.

(1) Method of Reading Necessary Minimum Data

In a case of using this method, the write processing unit 315 specifies a segment including logical sectors (target sectors) corresponding to the target area of the write command, with reference to the map information, and examines whether the specified segment includes any fraction before or after the target sectors.

(1-1) In a case where there is a fraction only before the target sectors (FIG. 7A), the write processing unit 315 outputs a read command including information specifying the logical sectors corresponding to the fraction part located before the target sectors (the target sectors may be excluded), to the disk device 20. Also, even in a case where a part corresponding to the target sectors expends over a plurality of segments, similarly, the write processing unit 315 outputs a read command including information specifying the logical sectors corresponding to the fraction part located before the target sectors (the target sectors may be excluded), to the disk device 20.

(1-2) In a case where there is a fraction only after the target sectors (FIG. 7B), the write processing unit 315 outputs a read command including information specifying the logical sectors corresponding to the fraction part located after the target sectors (the target sectors may be excluded), to the disk device 20. Also, even in a case where a part corresponding to the target sectors expends over a plurality of segments, similarly, the write processing unit 315 outputs a read command including information specifying the logical sectors corresponding to the fraction part located after the target sectors (the target sectors may be excluded), to the disk device 20.

(1-3) In a case where there are fractions before and after the target sectors (FIG. 7C), the write processing unit 315 outputs a read command including information specifying the logical sectors corresponding to the fraction parts located before and after the target sectors (the target sectors may be excluded), to the disk device 20. Also, even in a case where a part corresponding to the target sectors expends over a plurality of segments (FIG. 7D), similarly, the write processing unit 315 outputs a read command including information specifying the logical sectors corresponding to the fraction parts located before and after the target sectors (the target sectors may be excluded), to the disk device 20. Also, in this case, a method of reading an area expending over the front fraction part to the rear fraction part and including the target sectors may be more efficient than a method of reading the front fraction part and the rear fraction part in twice. Therefore, in this example, it is preferable to perform control such that the target sectors are included in a range to be read in response to the read command.

Also, as described above, in a case where fractions occur before and after the data of the target sectors, the write processing unit 315 examines the size of data which should be read according to the above described rule. If it is determined that the corresponding size exceeds a predetermined size (for example, about several times the size of a segment), the write processing unit 315 may output the input write command to the disk device 20, without reading data (without performing the fraction process of the present embodiment).

(2) Method of Reading Data More than Necessary Minimum Data

The write processing unit 315 may read data more than necessary minimum data. In this example, with reference to the map information, the write processing unit 315 specifies a segment including target sectors corresponding to the target area of the write command. Thereafter, the write processing unit 315 may output a read command including the specified segment and information specifying all logical sectors included in a predetermined number of segments following the specified segment (the target sector may be excluded), to the disk device 20. Also, in a case where the specified segment includes fraction parts before and after the target sectors, a method of reading an area expending over the front fraction part to the rear fraction part and including the target sectors may be more efficient than a method of reading the front fraction part and the rear fraction part in twice. Therefore, in this case, it is preferable to perform control such that the target sectors are included in a range to be read in response to the read command.

Also, in a case where the controller cache unit 33 retains data of the logical sectors included in the predetermined number of segments following the specified segment, the write processing unit 315 may read the corresponding data from the controller cache unit 33. Also, even in a case where the target sectors expend over a plurality of segments, the same process may be performed.

In this case, the number of segments following the specified segment is experientially determined by actually measuring the speed of processing while changing the number of segments. The reason is that it is considered that the optimal number of segments is influenced by the seek speed of storage disk devices and hit rate.

As described above, the write processing unit 315 obtains the fraction data located before or after the target area of the write command (or the data of a plurality of segments continuous to the target sectors corresponding to the target area), from the disk device 20, and stores the corresponding data in the controller cache unit 33. Therefore, a possibility that gap data between the target areas of write commands received in the past and the target area of the write command received at the current time is cached in the controller cache unit 33 increases.

[Target-Area Specifying Information of Write Command]

Now, an example in which the write command recording unit 316 records, as a least recently used (LRU) list, a target area history list on information in a write command output from the write processing unit 315 to the disk device 20 will be described.

In this example, if the write processing unit 315 outputs a write command to the disk device 20, the write command recording unit 316 extracts information representing a target area (for example, either the LBA (LBA_head) of the head of the target area and the write object data length LBN, or the LBA (LBA_head) of the head of the target area and an LBA after the write object data length LBN from the head LBA, that is, (LBA_head+LBN)), from the output write command. The following example will be described on the assumption that LBA_head and LBN have been obtained from the output write command. The write command recording unit 316 determines whether the output write command is a command subjected to a merging process by the write processing unit 315, based on whether information representing that a merging process was performed has been input from the command processing unit 314.

If the write command recording unit 316 determines that a merging process was performed, with reference to index information which is input from the close-area determining unit 312 (in a case where a merging process was performed, index information is surely input), the write command recording unit rewrites the LBA (LBA_head) of the head of the target area and the write object data length LBN recorded at a position, represented by the index information, in the target area history list, with the LBA (LBA_head) of the head of the target area and the write object data length LBN included in the write command output from the write processing unit 315 to the disk device 20. Also, the write command recording unit 316 moves the LBA (LBA_head) of the head of the target area and the write object data length LBN recorded at a position, represented by the index information, in the target area history list, to the head (the first position) of the target area history list. Similarly. LBA (LBA_head) of the head of the target area and the write object data length LBN recorded at the i-th position in the target area history list is sequentially moved to the (i+1)-th position (wherein “i” is an integer from 1 to (N−1)).

Also, if it is determined that a merging process was not performed, the write command recording unit 316 records the LBA (LBA_head) of the head of the target area and the write object data length LBN included in the write command output from the write processing unit 315 to the disk device 20, at the last of the target area history list. In this case, if there is already a record at the last of the target area history list (that is, if the target area history list includes the N-number of pairs of LBAs (LBA_head) of heads of the target area and write object data lengths LBN (wherein, “N” is the maximum length of the target area history list)), the write command recording unit rewrites the LBA (LBA_head) of the head of the target area and the write object data length LBN recorded at the last (N-th) position of the target area history list, with the LBA (LBA_head) of the head of the target area and the write object data length LBN included in the write command output from the write processing unit 315 to the disk device 20 (in a case where the target-area specifying information included in the write command is LBA_head and (LBA_head+LBN), the write command recording unit 316 may calculate the write object data length LBN from (LBA_head+LBN) and perform rewriting). Further, the write command recording unit 316 moves the head LBA_head and the length LBN of the write object data recoded at the last of the target area history list, to the head (the first position) of the target area history list. Similarly, the LBA (LBA_head) of the head of the target area and the write object data length LBN recorded at the i-th position in the target area history list is sequentially moved to the (i+1)-th position (wherein “i” is an integer from 1 to (N−1)). In this case, the LBA (LBA_head) of the head of the target area and the write object data length LBN recoded at the N-th place is deleted after the movement.

Also, if a flush command is input, the write command recording unit 316 clears the target area history list.

[Operations]

The storage control system 1 of the present embodiment has the above described configuration, and operates as follows. In the following operation example, an example in which the host side device 10 is a personal computer which operates by, for example, Windows (trademark) OS, and requests the storage control device 30 to record a number of files (for example, 10000 files) having relatively small sizes in the disk device 20 will be described. Like in this example, if the host side device 10 consecutively outputs write commands for writing files having relatively small sizes, control is frequently performed such that areas where data on the files are stored are spaced apart from one another. Also, the host side device 10 outputs data which unit size is called clusters.

Also, in the following operation example, an empty target area history list is set in the storage unit 32 of the storage control device 30 in advance. Also, it is assumed that the controller cache unit 33 is cleared in advance.

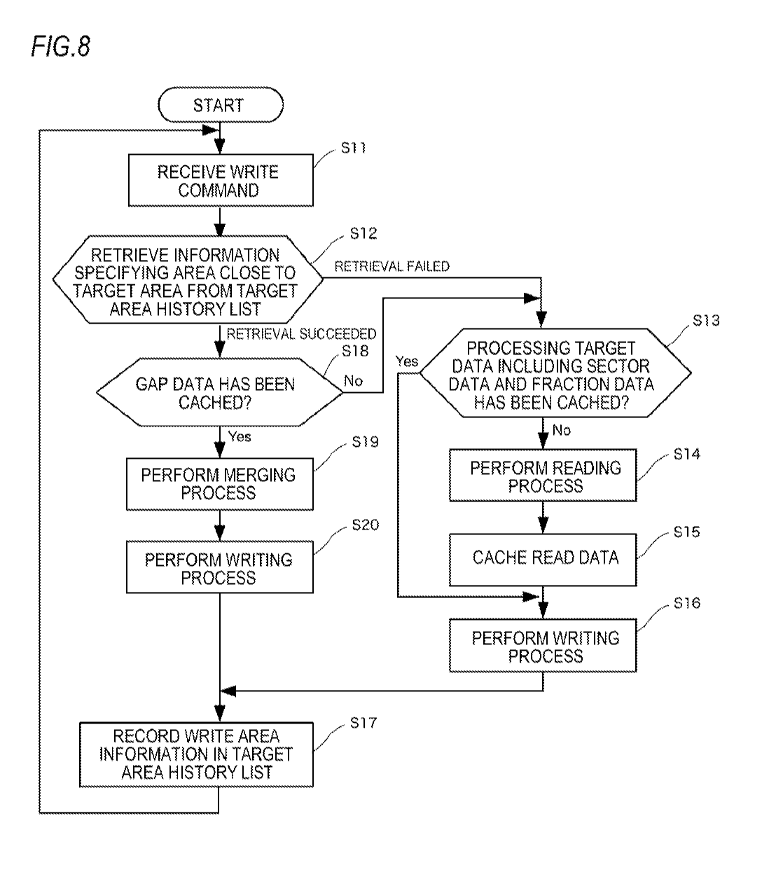

As shown in FIG. 8, in STEP S11, the storage control device 30 receives a write command from the host side device 10. For convenience of the following explanation, it is assumed that the received write command includes, as information specifying a target area, the LBA (LBA1_head) of the head of the target area and the write object data length LBN1. Also, it is assumed that the LBA (LBA1_last) is equal to (LBA1_head+LBN1).

In STEP S12 (retrieval of the closest history), from the information included in the target area history list, the storage control device 30 retrieves information specifying an area, closest to the target area specified by the information included in the write command received at the current time and having a gap from the target area specified by the information included in the write command received at the current time, smaller than the predetermined gap. The predetermined gap may be appropriately determined according to the applications of the host side device 10 requesting the disk device 20 to save files, or may be set to about several times (e.g. between two times and sixteen times) the size of a cluster.

In this stage, the target area history list is empty Therefore, the storage control device 30 determines that it was impossible in STEP S12 to retrieve area specifying information (“RETRIEVAL FAILED” in STEP S12), and performs processing based on the write command input from the host side device 10. In an example of the present embodiment, in STEP S13, the storage control device 30 sets logical sectors included in the target area specified by the information included in the write command, as target sectors, and determines whether the controller cache unit 33 retains data (processing target data) including at least a part which is included in data including at least one parity generation unit including fraction data and data (sector data) recorded in the target sectors but does not include the sector data (since the sector data will be overwritten, the sector data can be included in or excluded from the processing target data).

In this stage, since the controller cache unit 33 is also empty, the storage control device 30 determines that the processing target data has not been cached (“No” in STEP S13), and outputs a read command specifying, as a read target area, at least all logical sectors of a range of the disk device 20 retaining the processing target data, to the disk device 20, in STEP S14 (a reading process). In the present embodiment, in the reading process, the storage control device 30 may output a read command specifying, as a read target area, all logical sectors of the range retaining the processing target data and at least one logical sector following the corresponding range, to the disk device 20. In other words, in this case, if it is assumed that the LBA of the head of a segment including a range from LBA1_head to LBA1_last is LBAs_head, and the LBA of the last of the corresponding segment is LBAs_last, the storage control device 30 outputs a read command for reading a range from LBAs_head to LBAread_end (wherein LBAread_end≧LBAs_last), to the disk device 20.

Then, the disk device 20 outputs data in response to the corresponding read command, and the storage control device 30 receives the corresponding data, and caches the received data as processing target data in the controller cache unit 33 in STEP S15. In this stage, the controller cache unit 33 retains data of the segment including the target sectors designated as a rewiring object by the write command received in STEP S11 and data of the subsequent logical sectors (which may be designated in segment units for a fraction process) (data of logical sectors included in the range from LBAs_head to LBAread_end (wherein LBAread_end≧LBAs_last) received as processing target data from the disk device 20.

The storage control device 30 overwrites the data of a part, corresponding to a range from LBA1_head to LBA1_last, of the processing target data retained in the controller cache unit 33, with the write object data included in the write command received in STEP S11. Subsequently, the storage control device 30 extracts a part from LBAs_head to LBAs_last (data of a segment unit including a part corresponding to LBA1_head to LBA1_last) from the processing target data, and generates a write command including the extracted partial data as write object data and specifying the area of the corresponding range as a target area, and outputs the generated write command to the disk device 20, in STEP S16 (a writing process). The disk device 20 does not immediately process the write command but saves the write command in a device cache. Meanwhile, if it is determined in STEP S13 that processing target data has been cached (“Yes” in STEP S13), the storage control device 30 proceeds to STEP S16 and keeps processing.

Also, in STEP S17, the storage control device 30 records information specifying the area written by the generated write command (which is information including the LBA (LBAs_head) of the head of the target area and the length LBN (=LBAs_last−LBAs_head) and will be referred to as first write area information for convenience of explanation) in the target area history list. The first write area information is recorded at the head of the target area history list.

Then, the storage control device 30 returns to STEP S11 and keeps processing. In other words, in STEP S1, the storage control device 30 receives a write command from the host side device 10 again. For convenience of the following explanation, it is assumed that the received write command includes, as information specifying a target area, the LBA (LBA2_head) of the head of the target area and the write object data length LBN2. Also, it is assumed that the LBA (LBA2_last) is equal to LBA (LBA2_head+LBN2).

In STEP S12, the storage control device 30 retrieves information specifying a target area, closest to the target area specified by the information included in the write command received at the current time and having a gap smaller than the predetermined gap from the target area specified by the information included in the write command received at the current time, from the information included in the target area history list.

In this stage, for example, if LBA2_head is equal to (LBAs_last+α) and α is smaller than the predetermined gap, the storage control device 30 determines that area specifying information was in STEP S12 (“RETRIEVAL SUCCEEDED” in STEP S12), and determines whether gap data between the area specified by the information included in the target area history list and the target area specified by the information included in the write command received at the current time has been cached in the controller cache unit 33, in STEP S18. Here, the storage control device 30 determines whether the data of an area from (LBAs_last+1) to (LBA2_head−1) has been cached in the controller cache unit 33.

In this stage, if the LBA of the last of the data stored in STEP S15 satisfies a condition of [LBAread_end≧(LBAs_last+α)], it is determined that the data of the area from (LBAs_last+1) to (LBA2_head−1) has been cached in the controller cache unit 33. Meanwhile, if the LBA of the last of the data stored in STEP S15 satisfies a condition of [LBAread_end<(LBAs_last+α)], it is determined that the data of the area from (LBAs_last+1) to (LBA2_head−1) has not been cached in the controller cache unit 33.

If it is determined that gap data has not been cached in the controller cache unit 33 (“No” in STEP S18), like in the case where retrieval failed, the storage control device 30 proceeds to STEP S13 and keeps processing.

Meanwhile, in a case where it is determined that gap data has been cached in the controller cache unit 33 (“Yes” in STEP S18), in STEP S19, the storage control device 30 generates a write command using the write command received in STEP S11 at the current time and the gap data (a merging process).

In this merging process, since the LBA of the last of the area corresponding to the gap data is (LBA2_head−1), the storage control device 30 generates a write command including, as information specifying as a target area, the LBA (LBAs_last+1) of the head of the area corresponding to the gap data and the write object data length LBN (=L[Dm]+LBN2) (wherein, L[Dm] is the size of the gap data) and including, as write object data, data obtained by merging the gap data and the write object data included in the write command received in STEP S11 at the current time. Then, in STEP S20, the storage control device 30 outputs the generated write command to the disk device 20 (a writing process). The disk device 20 does not immediately process the write command but saves the write command in the device cache.

Also, the storage control device 30 proceeds to STEP S17, and records the information specifying the area (which is information including the LBA (LBAs_last+1) of the head of the target area and the length LBN (=L[Dm]+LBN2) and will be hereinafter referred to as second write area information for convenience of explanation) written in response to the generated write command, in the target area history list. The second write area information is recorded at the head of the target area history list, and the first write area information is moved to the second position of the target area history list.

Thereafter, if a predetermined timing comes, for example, if a predetermined time elapses from the previous writing process, the disk device 20 performs a writing process based on the write commands saved in the device cache.

In this writing process, the disk device 20 performs the following process while sequentially selecting the write commands saved in the device cache in the order of reception, as a selection write command. First, the disk device 20 refers to an area designated as a write target by the selection write command.

In this example, the selection write command selected for the first time includes LBAs_head as the LBA of the head of a target area, and includes (LBAs_last−LBAs_head) as the write object data length LBN. The disk device 20 examines whether any other write command for writing data in an area adjacent to the target area of the selection write command is located after the selection write command in the device cache.

In this stage, in the device cache, after the selection write command, there is the write command specifying (LBAs_last+1) as the head LBA. Therefore, the disk device 20 determines that another write command for writing data in an area adjacent to the target area of the selection write command is located after the selection write command in the device cache, and synthesizes the corresponding write command with the selection write command, thereby generating one write command.

Here, the disk device 20 generates a write command including, as information specifying a target area, information including LBAs_head as the LBA of the head of the target area and including (LBAs_last−LBAs_head+L[Dm]+LBN2) as the write object data length LBN, and including, as write object data, data obtained by merging the write object data of the selection condition and the write object data of the retrieved write command, and replaces the selection condition with the generated write command. Then, the disk device 20 deletes the retrieved write command from the device cache.

In response to the generated write command, the disk device 20 performs an operation of recording the merged data in the corresponding area of the disk drive 23, that is, the area starting from LBAs_head and having the length LBN (=LBAs_last−LBAs_head+L[Dm]+LBN2).

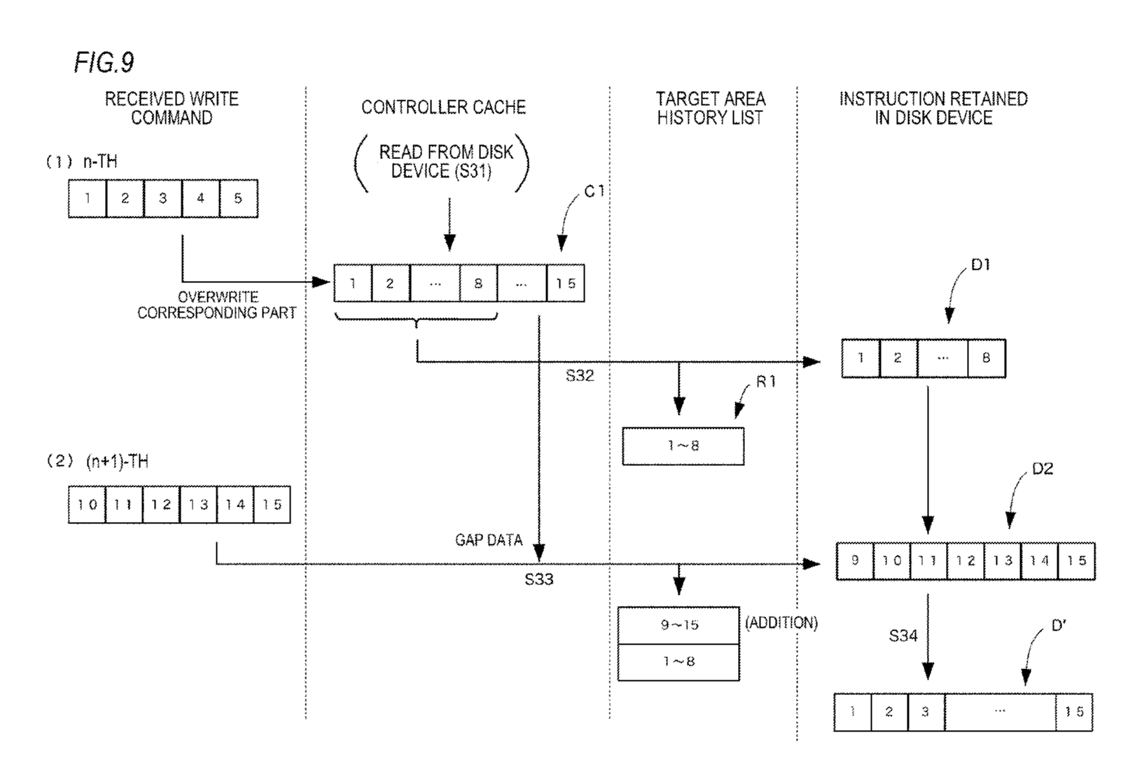

According to this example of the present embodiment, as conceptually shown in FIG. 9, first, when the storage control device 30 writes data in target areas (LBAs) 1 to 5 in response to an instruction from the host side device 10, it reads data (C1) stored areas (LBAs) 1 to 15, from the disk device 20, and stores the read data in the controller cache unit 33 (S31). The storage control device 30 overwrites a part, corresponding to the target areas 1 to 5, of the data stored in the controller cache unit 33, with the write object data, and instructs the disk device 20 to extract data of, for example, areas 1 to 8 including the target areas, from the controller cache unit 33, and write the extracted data (S32). The disk device 20 temporarily holds this instruction (D1). Also, the storage control device 30 records information specifying the areas (the areas 1 to 8) designated in the instruction, in a target area history list (R1).

Thereafter, if an instruction (a write command) representing that data should be written in areas 10 to 15 is received from the host side device 10, the storage control device 30 examines whether an area close to the areas 10 to 15 (for example, an area positioned within the distance of 5 from the areas 10 to 15) is in the areas specified by the information (R1) stored in the target area history list. In this stage, since the information specifying the areas 1 to 8 has been recorded, the storage control device 30 determines that the areas specified by the corresponding information are close to the target areas of the write command received at the current time.

Subsequently, the storage control device 30 examines whether gap data between the target areas (the areas 10 to 15) of the write command received at the current time and the areas (here, the areas 1 to 8) specified by the information included in the target area history list and determined as areas close to the target areas has been stored in the controller cache unit 33. In this stage, since the data of the area 9 is gap data and the controller cache unit 33 retains the data of the areas 1 to 15 (C1), the storage control device 30 determines that the gap data of the area 9 has been cached.

Therefore, the storage control device 30 generates a write command for writing the gap data of the area 9 together with the write object data of the write command received from the host side device 10 (S33). In other words, the storage control device overwrites the data of the areas 10 to 15 of the controller cache unit 33, with the write object data of the write command received from the host side device 10, and extracts the data of the areas 9 to 15 of the controller cache unit 33, and generates a write command including the extracted data as write object data and specifying the areas 9 to 15 as target areas, and outputs the generated write command to the disk device 20 (D2).

In the disk device 20, since the input write command is a write command specifying, as target areas, areas adjacent to the target areas of the saved instruction (D1), both commands are synthesized at a predetermined timing, and the synthesized command is processed as an instruction (D′) representing that data should be written in the areas 1 to 15.

As described above, in a case where write commands including instructions for writing data in areas with a small gap are individually input, like a case of individually writing data of files having relatively small sizes, the storage control device 30 controls the write commands such that the write commands are handled as an instruction for writing data in a continuous area in the disk device 20. Therefore, even in a case of repeatedly writing discontinuous data having relatively small sizes onto the disk device having a rotating medium, it is possible to improve the speed of the writing operation.

[Modifications]

The present embodiment is not limited to the above described examples. For example, in a case where the storage control device 30 consecutively receives write commands from the host side device 10, prior to start of processing on a previously input write command, the storage control device 30 may receive another write command. In this stage, in the storage control device 30, the plurality of write commands is temporarily retained. In this case, the storage control device 30 determines whether it is possible to synthesize the plurality of retained write commands. If synthesis is possible, the storage control device may synthesize the plurality of retained write commands, and provide the synthesized command to the subsequent process of the receiving unit 311 and the like.

Specifically, whether it is possible to synthesize the plurality of retained write commands is determined as follows. That is, when the write command is received at the current time, with reference to the information specifying the target area designated as a write target by the command received in the past, the storage control device 30 determines whether gap data between the target area (hereinafter, referred to as the first target area for convenience) specified by the referred information and the target area (hereinafter, referred to as the second target area for convenience) specified as a write target by the write command received at the current time has been cached in the controller cache unit 33. If the gap data has been cached, the storage control device determines that synthesis is possible. Even in this case, only when the gap between the first target area and the second target area is smaller than a predetermined threshold value, it may be determined that synthesis is possible.

If it is determined by the above described process that synthesis is possible, the storage control device 30 generates a write command representing that it is required to write the write object data (hereinafter, referred to as WD1) of the referred write command, the cached gap data Dmin, and the write object data (hereinafter, referred to as WD2) of the write command received at the current time.

In other words, when the LBA of the head of the first target area is equal to LBA1_head and the LBA of the head of the second target area is equal to LBA2_head, the storage control device 30 generates a write command specifying a smaller one of LBA1_head and LBA2_head as the LBA of the head of a target area and specifying (L[WD1]+L[Dm]+L[WD2]) as the write object data length LBN, and including, as write object data, data obtained by merging WD1, Din, and WD2 in the order of their LBAs. In this case, the storage control device deletes the two write commands (the write command including only the write object data WD1 and the write command including only the write object data WD2) used in the synthesis. The storage control device 30 considers the generated write command as having been received by the receiving unit 311, and processes it. Alternatively, in this case, the storage control device 30 may output the generated write command to the disk device 20, without processing it.

Although the configuration in which the storage control device 30 is provided separately from the host side device 10 has been described above, the present embodiment is not limited thereto. The host side device 10 and the storage control device 30 may be integrally formed. In other words, the host side device 10 may function as the storage control device 30. In this case, the control unit 31 of the storage control device 30 may be implemented by the CPU of the PC which is the host side device 10, and the storage unit 32 and the controller cache unit 33 may be implemented by using a memory of the PC. Specifically, the controller cache unit 33 can be implemented by securing a part of the memory of the host side device 10 as a cache memory area.

Also, in this case where the host side device 10 functions as the storage control device 30, a component corresponding to the first interface unit 34 is not indispensable.

Also, as another example, the storage control device 30 may be configured integrally with the disk device 20 (these components may be stored in one housing). In this case where the disk device 20 and the storage control device 30 are integrally configured, the device controller 22 of the disk device 20 may operate as the control unit 31 of the storage control device 30. Also, in this example, a component corresponding to the second interface unit 35 is not indispensable.

As described above, an embodiment of the present disclosure provides the storage control system 1 including the disk device 20 and the storage control device 30. The disk device 20 includes the device cache unit 222 that retains write commands including area specifying information specifying areas as write targets and including write object data as write objects, and the processor 221 that performs writing onto the disk drive 23 based on the retained write commands. The storage control device 30 includes the controller cache unit 33 in which data read from the disk device 20 is cached, the first interface unit 34 that receives write commands, the storage unit 32 that retains area specifying information included in write commands received in the past, and the control unit 31 that performs a write command generating process of generating a write command for writing write object data of a write command received at the current time and gap data between an area specified by area specifying information included in the write command received at the current time and an area specified by area specifying information included in the write command received at the past, in case it is determined that the gap data has been cached in the controller cache unit 33, with reference to area specifying information included in write commands received in the past and retained in the storage unit 32, and outputs the generated write command to the disk device 20.

Therefore, it is possible to make areas which data should be written by write commands a continuous area if it is possible. Therefore, even in a case of repeatedly writing discontinuous data having relatively small sizes onto the disk device 20 having a rotating medium, it is possible to improve the speed of the writing operation.

The storage unit 32 further retains the write commands received in the past. In case it is determined that the gap data between an area specified by area specifying information included in the write command received at the current time and an area specified by area specifying information included in the write command received at the past has been cached in the controller cache unit 33, with the reference to area specifying information included in the write commands received in the past and retained in the storage unit 32, the control unit 31 of the storage control device 30 performs a write command generating process of generating a write command for writing the write object data of the write command retained in the storage unit 32, the cached gap data, and the write object data of the write command received at the current time together, and outputs the generated write command to the disk device 20.

According to this process, in a case where the storage control device 30 retains a plurality of write commands standing by for processing, for example, a case where write commands are concentratedly received from the host side device 10 within a short time, the storage control device 30 merges the plurality of write commands if it is possible. Therefore, even in a case of repeatedly writing discontinuous data having relatively small sizes onto the disk device 20 having a rotating medium, it is possible to improve the speed of the writing operation.

In case it is determined that the gap between an area specified by area specifying information included in the write command received in the past and the area specified by the area specifying information included in the write command received at the current time is smaller than a predetermined gap, with reference to the area specifying information included in the write commands received in the past and retained in the storage unit 32, the control unit 31 of the storage control device 30 performs the write command generating process.

According to this example, it is possible to avoid merging from being performed with respect to a pair of write commands for instructing writing of data in areas with a gap larger than the predetermined gap.

What is claimed is:

1. A storage control system comprising:
a disk device; and
a storage control device, wherein
the disk device includes
a device cache memory configured to retain write commands including area specifying information specifying areas as write targets and including write object data as write objects; and
device circuitry configured to perform writing onto a disk based on the retained write commands, and
the storage control device includes a controller cache memory in which data read from the disk device is cached;
an interface configured to receive write commands;
a controller memory configured to retain area specifying information included in write commands received at a first point of time; and
controller circuitry configured to
perform a write command generating process of generating a write command for writing write object data of a write command received at a second point of time later than the first point of time and gap data between an area specified by area specifying information included in the write command received at the second point of time and an area specified by area specifying information included in the write command received at the first point of time, in case it is determined that the gap data has been cached in the controller cache memory, with reference to the area specifying information included in the write commands received at the first point of time and retained in the controller memory; and
output the generated write command to the disk device.

2. The storage control system according to claim 1,
wherein the controller memory is further configured to retain the write commands received at the first point of time, and
wherein, in case it is determined that the gap data between the area specified by area specifying information included in the write command received at the second point of time and the area specified by area specifying information included in the write command received at the first point of time has been cached in the controller cache memory, with the reference to the area specifying information included in the write commands received at the first point of time and retained in the controller memory, the controller circuitry of the storage control device performs a write command generating process of generating a write command for writing the write object data of the write command retained in the controller memory, the cached gap data, and the write object data of the write command received at the second point of time together, and outputs the generated write command to the disk device.

3. The storage control system according to claim 1,
wherein in a case where the gap data has not been cached in the controller cache memory, the controller circuitry reads at least a part of data of an expanded area including the area specified by the area specifying information included in the write command received at the second point of time and an area continuous to the specified area, from the disk device, and caches the read data in the controller cache memory.

4. The storage control system according to claim 3,
wherein the controller circuitry is further configured to:
read data in predetermined units from the disk device;
designate, as the expanded area data, data of one or more predetermined units including the area specified by the area specifying information included in the write command received at the second point of time;
read at least a part of the expanded area data from the disk device; and
cache the read data in the controller cache memory.

5. The storage control system according to claim 4,
wherein in case it is determined that the size of data which should be read as the expanded area data from the disk device exceeds a predetermined size, the controller circuitry outputs the write command received at the second point of time to the disk device, without reading the expanded area data and performing the write command generating process.

6. The storage control system according to claim 3,
wherein in a case where the gap data has not been cached in the controller cache memory, the controller circuitry reads the whole of the data of the expanded area data including the area specified by the area specifying information included in the write command received at the second point of time and the area continuous to the specified area, from the disk device, and caches the read data in the controller cache memory.

7. The storage control system according to claim 1,
wherein the controller circuitry is further configured to retrieve closest-area specifying information specifying an area closest to the area specified by the area specifying information included in the write command received at the second point of time, from the areas specified by the area specifying information included in the plurality of write commands received at the first point of time and retained in the controller memory, and
wherein, in case that gap data between the closest area specified by the closest-area specifying information and the area specified by the area specifying information included in the write command received at the second point of time has been cached in the controller cache memory, the controller circuitry performs a write command generating process of generating a write command for writing the cached gap data and the write object data included in the write command received at the second point of time, together, and outputs the generated write command to the disk device.

8. The storage control system according to claim 1,
wherein in case it is determined that the gap between an area specified by area specifying information included in the write command received at the first point of time and the area specified by the area specifying information included in the write command received at the second point of time is smaller than a predetermined gap, with reference to the area specifying information included in the write commands received at the first point of time and retained in the controller memory, the controller circuitry of the storage control device performs the write command generating process.

9. The storage control system according to claim 1,
wherein the device circuitry is further configured to perform writing onto the disk at a predetermined timing, and
wherein, at the predetermined timing, in a case where the device cache memory retains a plurality of write commands including area specifying information specifying areas adjacent to each other, the device circuitry synthesizes the plurality of write commands, thereby generating one write command specifying the corresponding areas, and performs writing onto the disk based on the generated write command.

10. The storage control system according to claim 1, wherein the second point of time is current time.

11. The storage control system according to claim 1, wherein the controller circuitry is further configured to determine the gap data has been cached in the controller cache memory.

12. A storage control device connected to a disk device, the disk device being configured to retain write commands including area specifying information specifying areas as write targets and including write object data as write objects and perform writing onto a disk based on the retained write commands, the storage control device comprising:
a controller cache memory, in which data read from the disk device is cached;
an interface configured to receive write commands;
a controller memory configured to retain area specifying information included in write commands received at a first point of time; and
controller circuitry configured to
perform a write command generating process of generating a write command for writing write object data of a write command received at a second point of time later than the first point of time and gap data between an area specified by area specifying information included in the write command received at the second point of time and an area specified by area specifying information included in the write command received at the first point of time, in case it is determined that the gap data has been cached in the controller cache memory, with reference to the area specifying information included in the write commands received at the first point of time and retained in the controller memory; and
output the generated write command to the disk device.

13. The storage control device according to claim 12,
wherein in a case where the gap data has not been cached in the controller cache memory, the controller circuitry reads at least a part of data of an expanded area including the area specified by the area specifying information included in the write command received at the second point of time and an area continuous to the specified area, from the disk device, and caches the read data in the controller cache memory.

14. The storage control device according to claim 13,
wherein the controller circuitry is further configured to:
read data in predetermined units from the disk device;
designate, as the expanded area data, data of one or more predetermined units including the area specified by the area specifying information included in the write command received at the second point of time;
read at least a part of the expanded area data from the disk device; and
cache the read data in the controller cache memory.

15. The storage control device according to claim 14,
wherein in case it is determined that the size of data which should be read as the expanded area data from the disk device exceeds a predetermined size, the controller circuitry outputs the write command received at the second point of time to the disk device, without reading the expanded area data and performing the write command generating process.

16. The storage control device according to claim 13,
wherein in a case where the gap data has not been cached in the controller cache memory, the controller circuitry reads the whole of the data of the expanded area data including the area specified by the area specifying information included in the write command received at the second point of time and the area continuous to the specified area, from the disk device, and caches the read data in the controller cache memory.

17. The storage control device according to claim 12,
wherein the controller circuitry is further configured to retrieve closest-area specifying information specifying an area closest to the area specified by the area specifying information included in the write command received at the second point of time, from the areas specified by the area specifying information included in the plurality of write commands received at the first point of time and retained in the controller memory, and
wherein, in case that gap data between the closest area specified by the closest-area specifying information and the area specified by the area specifying information included in the write command received at the second point of time has been cached in the controller cache memory, the controller circuitry performs a write command generating process of generating a write command for writing the cached gap data and the write object data included in the write command received at the second point of time, together, and outputs the generated write command to the disk device.

18. The storage control device according to claim 12,
wherein in case it is determined that the gap between an area specified by area specifying information included in the write command received at the first point of time and the area specified by the area specifying information included in the write command received at the second point of time is smaller than a predetermined gap, with reference to the area specifying information included in the write commands received at the first point of time and retained in the controller memory, the controller circuitry of the storage control device performs the write command generating process.

19. A computer-readable non-transitory storage medium including executable instructions, which can be executed by a processor of a storage control device connected to a disk device, the executable instructions when executed by the processor, causing the processor to
cache data read from the disk device in a controller cache memory of the storage control device, the disk device being configured to retain write commands including area specifying information specifying areas as write targets and including write object data as write objects and perform writing onto a disk based on the retained write commands;
receive write commands through an interface;
save, in a controller memory of the storage control device, area specifying information included in write command received at a first point of time;
perform a write command generating process of generating a write command for writing write object data of a write command received at a second point of time later than the first point of time and gap data between an area specified by area specifying information included in the write command received at the second point of time and an area specified by area specifying information included in the write command received at the first point of time, in case it is determined that the gap data has been cached in the controller cache memory, with reference to the area specifying information included in the write commands received at a first point of time and retained in the controller memory, and
output the generated write command to the disk device.
